(19) United States
(12) Patent Application Publication
(10) Pub. No.: US 2011/0154441 A1
(43) Pub. Date: Jun. 23, 2011

(54) ONLINE DEVELOPMENT ENVIRONMENT SERVER, ONLINE MARKETPLACE SERVER, ONLINE DEVELOPMENT ENVIRONMENT CONSTITUTING METHOD, AND DEVELOPED APPLICATION PROVIDING METHOD

(75) Inventors: Byeong Thaek OH, Daejeon (KR); Sung Ik JUN, Daejeon (KR); Sung Jin HUR, Daejeon (KR)

(73) Assignee: Electronics and Telecommunications Research Institute, Daejeon (KR)

(21) Appl. No.: 12/970,289

(22) Filed: Dec. 16, 2010

(30) Foreign Application Priority Data
Dec. 18, 2009 (KR) 10-2009-0127540
Oct. 19, 2010 (KR) 10-2010-0101838

(51) Int. Cl. G06F 9/44; G06F 21/00

(52) U.S. Cl. 726/3; 717/105

(57) ABSTRACT

An online development environment server, online marketplace server, an online development environment configuring method, and a developed application providing method are provided. The online development environment server includes: a virtual resource pool providing virtual resources including a design tool pool, an IDE/SDK pool, a service component, and a virtual server and repository pool; a virtual resource pool manager supporting to allow a developer to select a virtual resource according to a selected development environment; a virtual development environment manager establishing a virtual development environment with reference to virtual resource information through the virtual resource pool manager; a virtual operation space and view manager binding a user and a view of a virtual development environment of each group through the virtual development environment manager and the virtual resource pool manager; a presenter presenting a virtual view model constituted by being bound by the virtual operation space and view manager; and a metadata manager storing metadata configured for virtualizing an operation space and managing the same.

### CROSS-REFERENCE TO RELATED APPLICATIONS

This application claims the priority of Korean Patent Application Nos. 10-2009-0127540 filed on Dec. 18, 2009 and 10-2010-0101838 filed on Oct. 19, 2010, in the Korean Intellectual Property Office, the disclosures of which are incorporated herein by reference.

### BACKGROUND OF THE INVENTION

1. Field of the Invention

The present invention relates to an online development environment server, online marketplace server, an online development environment configuring method, and a developed application providing method and, more particularly, to an online development environment server virtualized to enable a constitution of a customized development environment, an online marketplace server supporting extendibility and flexibility in association with the online development environment server, and a technique for operating the servers to configure an online development environment and provide a developed application.

2. Description of the Related Art

Software developers have made many efforts to establish a development environment by selecting and combining proper tools among a variety of tools such as a software (SW) designing tool, an implementation tool, a testing tool, and a distribution tool, and in this case, in actuality, each developer needs to personally have a personal PC or a server and establish a development environment by purchasing an operating system, a WAS (Web Application Server), and the like, incurring a great deal of cost for establishing the development environment.

Recently, online development environments have been provided by Salesforce.com, Google, Microsoft, and the like, but these online development environments are very limited and do not support the reuse of developed codes.

In detail, in the case of Salesforce.com, Development as a service (DaaS) supports a Web-based Force.com Builder and an Eclipse-based Force.com IDE as an online development environment for supporting a development of an application service operated on a DaaS platform called Force.com, and provides a testing server along with a development server. However, DaaS provides a very limited development environment, so the user cannot select and configure a development environment as a customized development environment and can neither download nor reuse a developed code.

In the case of Google, a Web application can be established by using Google Application Engine (GAE), but it only supports a Python 2.5.2 and Java English (JRE 6) execution environment.

In the case of Microsoft, the Azure Services Platform provides a development environment by using an SDK accessing Windows Azure called Azure Runtime to support a cloud computing and general application SW development. However, a user cannot select and configure a customized development environment, cannot reuse a developed application code, and is not provided with a marketplace for operating applications developed in various environments.

### SUMMARY OF THE INVENTION

An aspect of the present invention provides an online development environment server virtualized to enable a configuration of a customized development environment, an online marketplace server supporting extendibility and flexibility in association with the online development environment server, a method for operating the servers to configure an online development environment, and a method for providing a developed application.

According to an aspect of the present invention, there is provided an online development environment server including: a virtual resource pool providing virtual resources including a design tool pool, an IDE/SDK pool, a service component, and a virtual server and repository pool; a virtual resource pool manager supporting to allow a developer to select a virtual resource according to a selected development environment; a virtual development environment manager establishing a virtual development environment with reference to virtual resource information through the virtual resource pool manager; a virtual operation space and view manager binding a user and a view of a virtual development environment of each group through the virtual development environment manager and the virtual resource pool manager; a presenter presenting a virtual view model constituted by being bound by the virtual operation space and view manager; and a metadata manager storing metadata configured for virtualizing an operation space and managing the same.

According to another aspect of the present invention, there is provided an online marketplace server including: an online marketplace portal supporting to allow a user to check a list of applications and Web services, and make a contract to use a desired application and a desired Web service; an application manager managing a list of applications approved to be operated and supporting checking an application list and downloading of an application package through the online marketplace portal; a provisioner disposing an application approved to be operated or a service component to allocate resources; a virtual resource pool providing virtual resources including an application, a service component, a multi-tenant support runtime engine pool, a metadata manager, and a virtual server and repository pool; a virtual resource pool manager establishing a virtual environment to allow a user to use an operating system and a server according to a desired application; and a metadata manager storing and managing metadata for driving an application.

The online marketplace server may further include: a charging manager (or a billing manager) performing a charging function with reference to license information of an application and a Web service and user's contract information; and a connection control and security manager managing controlling a connection of a developer and a user, the security of a communication channel, and the security of the online marketplace server, and handling an authentication when the developer and the user logs in.

According to another aspect of the present invention, there is provided a method for configuring an online development environment, including: checking developer registration information according to a request for authenticating a developer received from a developer terminal, and approving a log-in of a developer; displaying a list of supportable operating systems through the developer terminal; displaying a supportable WAS (Web Application Server), a frame work, and a list of design and development tools through the developer terminal; constituting a virtual design and development space according to a selected development environment and whether or not a collaborative engineering development is to be made received from the developer terminal; establishing, by the developer terminal, an environment for the configured virtual design and development space; and storing environment configuration information of the developer terminal in an online development environment server.

According to another aspect of the present invention, there is provided a method for providing an application, including: performing packaging according to an application and a service component packaging request received from a developer terminal; storing application and service component information received from the developer terminal; checking developer information to perform authentication according to a developer authentication request received from the developer terminal; when a request for disposing an application and service and an evaluation is received from the authenticated developer, transmitting a selected application and service packet to an online marketplace server; disposing and provisioning the selected application and service package and the performing evaluation; and disposing a new service component approved to be operated in a virtual resource pool.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating an overall online development environment system according to an exemplary embodiment of the present invention;

FIG. 2 is a detailed block diagram of an online development environment server according to an exemplary embodiment of the present invention;

FIG. 3 is a detailed block diagram of an online marketplace server according to an exemplary embodiment of the present invention;

FIG. 4 is a flow chart illustrating the process of configuring an online development environment using the online development environment server; and

FIG. 5 is a flow chart illustrating the process of providing a developed application by using the online development environment server and the online marketplace server.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert the gist of the present invention, such explanation will be omitted but would be understood by those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

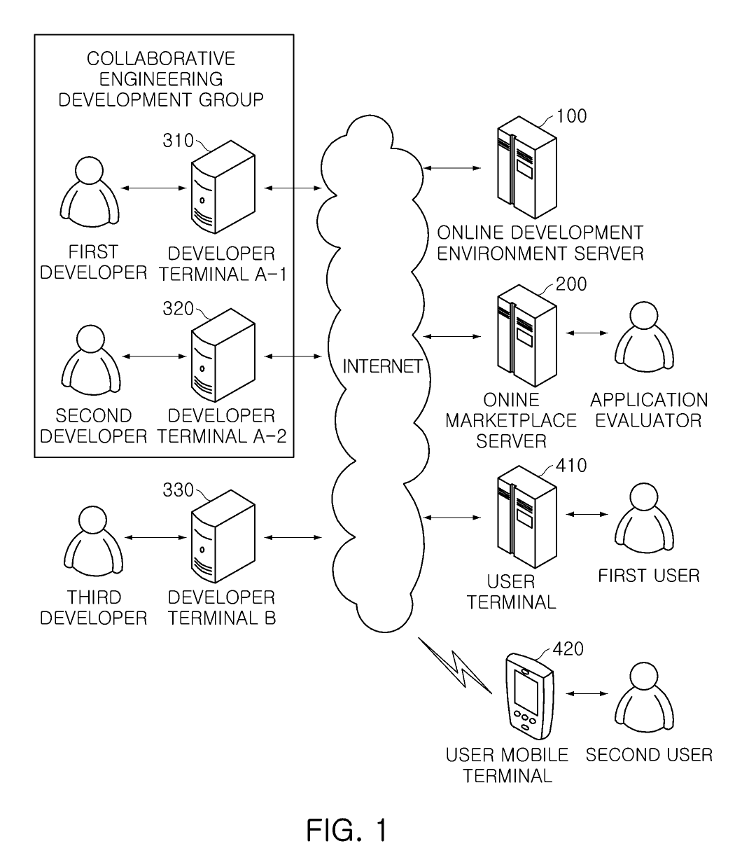

FIG. 1 is a view illustrating an overall online development environment system according to an exemplary embodiment of the present invention.

An online development environment system according to an exemplary embodiment of the present invention may be configured to include an online development environment server 100, an online marketplace server 200, one or more developer terminals 310, 320, and 330, and one or more user terminals 410 and 420, and these elements are connected through the Internet, or the like.

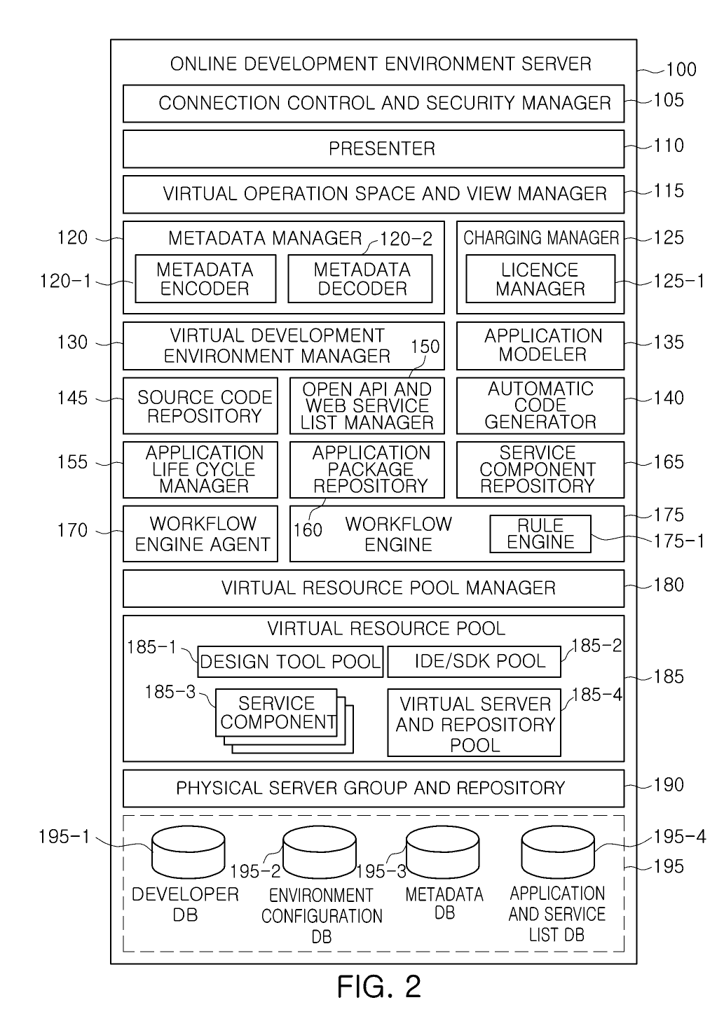

The online development environment server 100 serves to provide a customized software development environment to a software developer online. A detailed configuration and function of the online development environment server 100 will be described in detail with reference to FIG. 2.

The online marketplace server 200 serves to operate an application developed in a development environment provided by the online development environment server 100. A detailed configuration and function of the online marketplace server 200 will be described in detail with reference to FIG. 2.

One or more developer terminals 310, 320, and 330 are connected to the online development environment server 100 through the Internet to provide a customized software development environment to developers. In other words, the first to third developers may be connected to the online development environment server 100 through the developer terminals 310, 320, and 330, respectively, to configure a customized development environment fitting their requirements and then develop software. In particular, the first and second developers may be connected to the online development environment server 100 through the developer terminals 310 and 320 and collaboratively perform a development task. Also, in developing an application, the first to third developers may develop a new application by using already developed components in the development environment provided by the online development environment server 100.

The one or more user terminals 410 and 420 are connected to the online marketplace server 200 through the Internet to provide a developed application to the user. In other words, the first and second users are connected to the online marketplace server 200 through the user terminals 410 and 420, respectively, to selectively use an already developed application or a desired application of a Web service, or a Web service, and if necessary, the first and second user may download an application package through their user terminals 410 and 420, dispose the downloaded application package in a personal server, and operate it.

In the present exemplary embodiment, a testing environment server is not illustrated and the online marketplace server 200 evaluates an application and a service component. However, the present invention is not limited thereto, and a testing environment server (not shown), which is substantially the same as the online marketplace server 200, may be provided to receive an application or a service component developed by the online development environment server 100, evaluate them, and transmit the evaluation results to the online development environment server 100 and the online marketplace server 200.

FIG. 2 is a detailed block diagram of the online development environment server according to an exemplary embodiment of the present invention. The online development environment server 100 may be configured to include a connection control and security manger 105, a presenter 110, a virtual operation space and view manager 115, a metadata manager 120 including a metadata encoder 120-1 and a metadata decoder 120-2, a charging manager (or a billing manager) 125 including a license manager 125-1, a virtual development environment manager 130, an application modeler 135, an automatic code generator 140, a source code repository 145, an open API and Web service list manager 150, an application life cycle manager 155, an application package repository 160, a service component repository 165, a workflow engine agent 170, a workflow engine 175 including a rule engine 175-1, a virtual resource pool manager 180, a virtual resource pool 185 including a design tool pool 185-1, an IDE/SDK pool 185-2, a service component 185-3, a virtual server and repository pool 185-4, a physical server group and repository 190, and a DB 195 including a developer DB 195-1, an environment configuration DB 195-2, a metadata DB 195-3, and an application and service list DB 195-4.

The connection control and security manager 105 manages controlling of a user connection, security on a communication channel, and security of the overall online development environment server 100 when a developer uses an online development environment through the Internet. Also, when the developer logs in, the connection control and security manager 105 handles a developer authentication.

The presenter 110 serves to present a virtual view model configured by being bound by the virtual operation space and view manager 115 to the developer.

The virtual operation space and view manager 115 binds a view of a virtual development environment of each user and each group through the virtual development environment manager 130 and the virtual resource pool manager 180 and provides the same.

The metadata manager 120 serves to store metadata constituted for virtualizing an operation space by using the metadata encoder 120-1 and the metadata decoder 120-2 and retrieve the stored metadata. In detail, virtual operation space environments and development environment configuration matters selected by the developer are stored and managed. Also, when a customized function for supporting a multi-tenant with a developed application is developed, a user interface, a database, a workflow, and the like, may be stored in the metadata DB 195-3 by using the metadata encoder 120-1, and when an application is driven, a customized application may be configured by using the metadata retrieved from the metadata DB 195-3 by using the metadata decoder 120-2.

The charging manager 125 performs a function of charging with reference to development environment and development tool license information and developer's contact information by using the license manager 125-1. The license manager 125-1 manages the license of a development environment and development tool including WAS.

The virtual development environment manager 130 serves to establish a virtual development environment with reference to virtual resource information through the virtual resource pool manager 180 within the online development environment server 100.

The application modeler 135 is a modeling tool provided by the online development environment server 100. The developer can model an application by using the application modeler 135.

The automatic code generator 140 serves to generate a code with respect to an application modeled by the application modeler 135.

The source code repository 145 stores source codes, which have been generated by the developer by using the application modeler 135 and the automatic code generator 140 by version and manages the same. Also, the source code repository 145 classifies the automatically generated code and source codes developed by the developer and stores the same to allow all the developers to use them in developing an application.

The open API and Web service list manager 150 manages an open API and Web service list provided by a Web-based server, and supports to allow the developer to apply the open API and Web service list in developing an application by using the virtual development environment or by using the application modeler 135.

The application life cycle manager 155 manages information regarding an evaluation, a disposition, and discarding in stages of developing each application. Detailed information of a corresponding application is stored in the application and service list DB 195-4 and managed. Also, the same information as that managed by the application life cycle manager 155 is also managed by the application life cycle manager 235 of the online marketplace server 200 (to be described).

The application package repository 160 is a space for packaging source codes developed by the developer and storing and managing the same by utilizing the codes of the source code repository 145, and the service component repository 165 is a space for packaging service components developed by the developer and storing and managing the same.

After the packaging operation is performed, the developer transmits an application or a service component to the online market place server 200 and requests its evaluation. After the application or the service components are evaluated by an evaluator in the online marketplace server 200, the service component approved for its operation may be disposed as a service component 185-3 of the virtual resource pool 185 of the online it in using a virtual development environment server 100 so that the developer may apply it in developing a different application. In addition, the service component approved for its operation may be also disposed as a service component 265-2 of the virtual resource pool 265 of the online marketplace server 200 so that applications developed by the developer by using the corresponding service components in the virtual development environment can be executed on a virtualized server.

The workflow engine 175 includes the rule engine 175-1. When the developer develops a process application employing a workflow and a rule, the workflow engine 175 provides an API to the workflow agent 170 to support the development.

Like the foregoing service component, after the application, which has been developed by the developer by using the workflow engine agent 170 in the online development environment server 100, is disposed in the online marketplace server 200, the developed application may be executed by using the workflow engine 255 including the same rule engine 255-1 installed in the online marketplace server 200 and the workflow engine agent 250.

The virtual resource pool manager 180 serves to support to allow the developer to select a proper virtual resource in selecting and setting his development environment.

The virtual resource pool 185 includes the design tool pool 185-1, the IDE/SDK pool 185-2, the service component 185-3, and the virtual server and repository pool 185-4. In detail, the virtual resource pool 185 provides the virtual server and repository pool 185-4 by virtualizing the physical server group and repository 190 and the operating system (OS), and constitutes the overall virtual resource pool 185 by including the design tool pool 185-1 and the IDE/SK pool 185-2 on a server of each operating system along with the virtual server and repository pool 185-4. In addition, the service component 185-3 supports an application development in a virtual development environment configured by the user along with the IDE/SDK.

The DB 195 serves to store various types of data required for the online development environment server 100. The DB 195 may include the developer DB 195-1 storing information regarding each developer, the environment configuration DB 195-2 storing environment configuration information regarding a virtual development environment, the metadata DB 195-3 storing metadata, and the application and service list DB 195-4 storing detailed information regarding each stage of an application development.

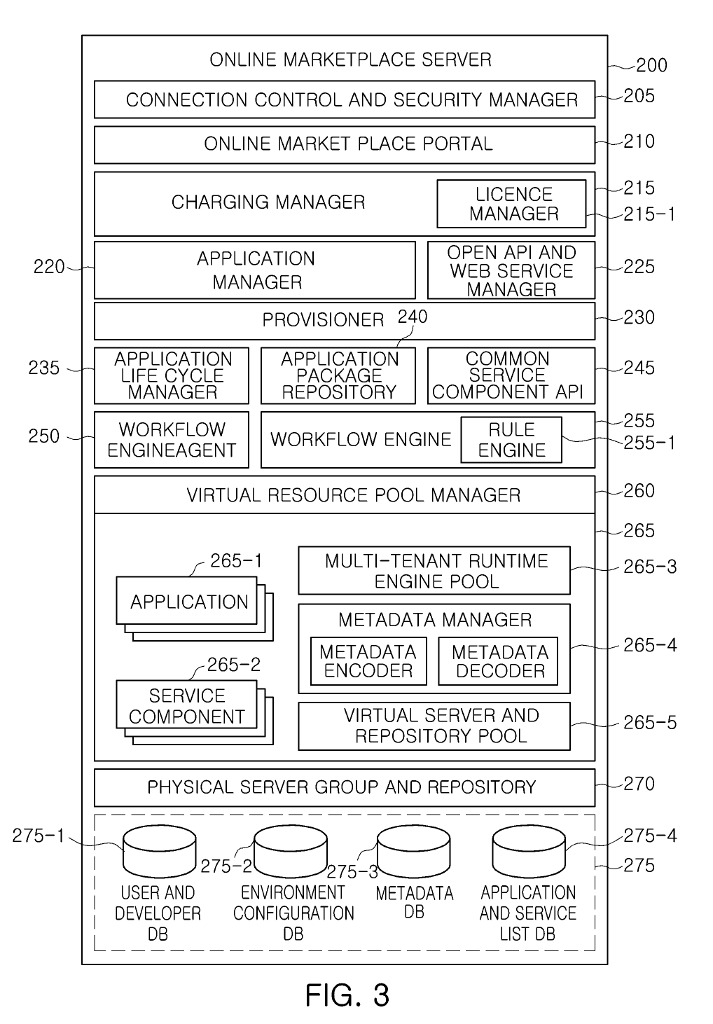

FIG. 3 is a detailed block diagram of an online marketplace server according to an exemplary embodiment of the present invention. The online marketplace server may be configured to include a connection control and security manager 205, an online marketplace portal 210, a charging manager 215 including a license manager 215-1, an application manager 220, an open API and Web service manager 225, a provisioner 230, an application life cycle manager 235, an application package repository 240, a common service component API 245, a workflow engine agent 250, a workflow engine 255 including a rule engine 255-1, a virtual resource pool manager 260, a virtual resource pool 265 configured with resources of an application 265-1, a service component 265-2, a multi-tenant support runtime engine pool 265-3, a metadata manager 265-4 including a metadata encoder and a metadata decoder, a virtual server and repository pool 265-5, a physical server group and repository 270, a DB 275 including a user and developer DB 275-1, an environment configuration DB 275-2, a metadata DB 275-3, an application and service list DB 275-4, and the like.

The connection control and security manager 205 manages controlling of a developer and user connection, security on a communication channel, and security of the overall online marketplace server 200 when a developer and a user use an online marketplace through the Internet. Also, when the developer and the user log in, the connection control and security manager 205 authenticates the developer and the user.

The online marketplace portal 210 serves to provide a function of allowing the user to check a list of application 265-1 and Web service 225 and make a contract to use a desired application and a desired Web service.

The charging manager 215 performs a function of charging with reference to license information of the application 260-1 and Web service 225 and user's contact information by using the license manager 215-1. The license manager 215-1 manages the license of the application 265-1 and the Web server 225.

The application manager 220 manages the list of applications approved to be operated after having been developed by the developer and then evaluated by an evaluator. The application manager 220 supports to allow the user to check the application list through the online marketplace portal 210, and also supports to allow the user to download and use an application package if necessary, after making the contract.

The open API and Web service manager 225 manages a list of open API and Web services used by an application which has been developed by the developer and finally disposed, and a service status. Also, the open API and Web service manager 225 may perform a function of providing an open API and Web service to external servers by using service components disposed after being developed by the developer.

The provisioner 230 serves to dispose an application or service component, which has been approved to be operated by the online marketplace server 200, in the online marketplace server 200 and allocate resources. After provisioning, the application is driven on the corresponding multi-tenant support runtime engine pool 265-3 to support to allow multiple users and tenants to use the application. The multi-tenant support runtime engine may be configured to be different according to each virtual server, operating system, WAS (Web Application Server), or the like, so as to perform a function of providing a service by supporting multiple tenants with a single application instance.

The application life cycle manager 235 manages information regarding an evaluation, a disposition, and discarding in stages of developing each application. Detailed information of a corresponding application is stored in the application and service list DB 275-4 and managed. Also, as discussed above, the same information as that managed by the application life cycle manager 235 is also managed by the application life cycle manager 155 of the online development environment server 100.

The application package repository 240 stores and manages an application and service package which has been developed by the developer and then transmitted to the online marketplace server 200, and also handles a function of supporting to download the application and service package through the application manager 220 according to the user's contract.

The common service component API 245 is transmitted to and stored in the online marketplace server 200 when the online marketplace server 200 wants to support a development by adding a common service, among the service components developed by the developer in the online development environment server 100.

The workflow engine agent 250 and the workflow engine 255 including the rule engine 255-1 operate the same target (or object) as that operated by the online development environment server 100, and are used when an application developed in the online development environment server 100 performs a process management function in the online marketplace server 200.

The virtual resource pool manager 260 handles establishing a virtual environment to allow the user to use an operating system and server according to a desired application.

The virtual resource pool 265 includes the application 265-1, the service component 265-2, the multi-tenant support runtime engine pool 265-3, the metadata manager 265-4 including the metadata encoder and the metadata decoder, and the virtual server and repository pool 265-5.

The metadata manager 265-4 stores configuration information regarding a user interface, a database, a workflow, and the like, in the metadata DB 275-3 through the metadata encoder when the user or the tenant performs customizing to use an application, and when the application is desired to be driven, the metadata manager 265-4 supports to allow the application to be driven according to the configuration information through the metadata decoder.

The DB 275 serves to store various types of data required for the online marketplace server 200. The DB 275 may include the user and developer DB 275-1 storing information regarding each user and each developer, the environment configuration DB 275-2 storing environment configuration information, the metadata DB 275-3 storing metadata, and the application and service list DB 275-4 storing detailed information regarding each stage of an application development.

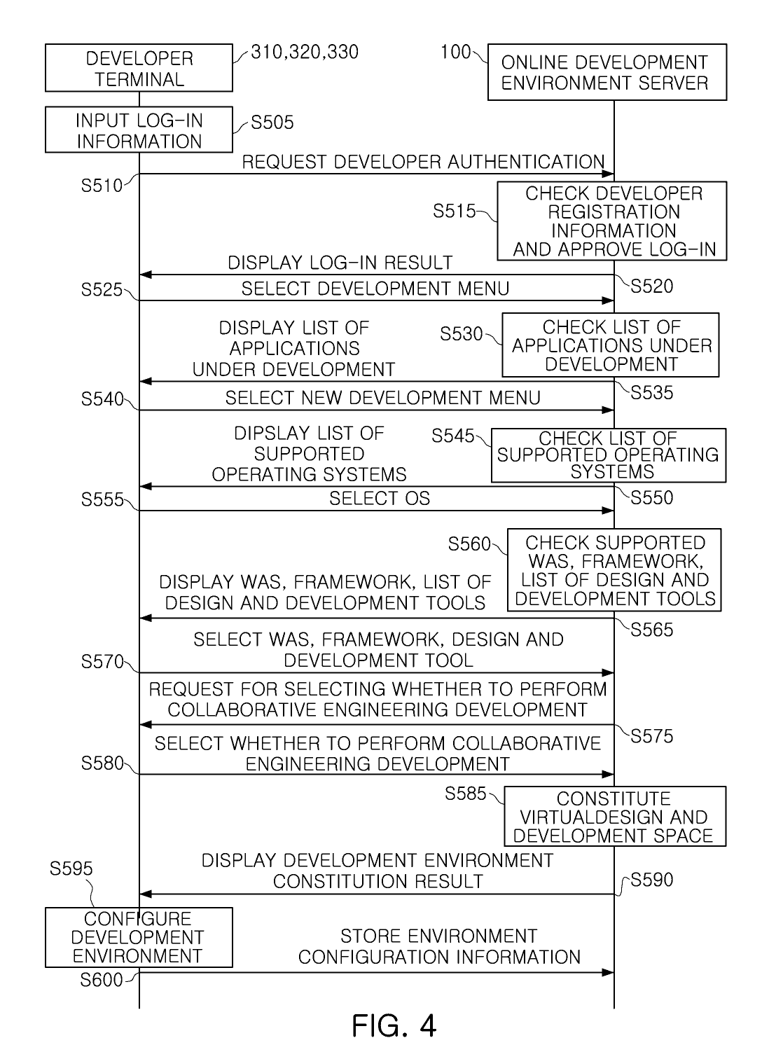

FIG. 4 is a flow chart illustrating the process of configuring an online development environment using the online development environment server.

With reference to FIG. 4, first, when the developer inputs log-in information in the developer terminals 310, 320, and 330 (step S505), the developer terminals 310, 320, and 330 request the online development environment sever 100 to authenticate the developer (step S510).

The online development environment server 100 checks registration information of the developer with reference to the developer DB, approves the log-in (step S515), and displays the log-in results through the developer terminals 310, 320, and 330 (step S520).

After log-in, the developer starts developing by selecting a development menu (step S525).

Thereafter, the online development environment server 100 checks the list of applications under development by the corresponding developer (step S530). If there is an application under development by the developer, the online development environment server 100 displays the corresponding information through the developer terminals 310, 320, and 330 (step S535). When the developer selects the application whose development is desired to be proceeded with, a previously selected development environment is reconfigured.

Meanwhile, when the developer selects a new development menu from the developer terminals 310, 320, and 330 and delivers the same to the online development environment server 100 (step S540), the online development environment server 100 checks the list of supported operating systems (OS) (step S545) and displays the list of supported OS through the developer terminals 310, 320, and 330 (step S550).

When the developer selects an OS from the developer terminals 310, 320, and 330 and delivers the same to the online development environment server 100 (step S555), the online development environment server 100 checks a supportable WAS, framework, and design and development tool list (step S560) and displays the development environment through the developer terminals 310, 320, and 330 (step S565).

Accordingly, the developer selects a desired development environment from the developer terminals 310, 320, and 330 and delivers the same to the online development environment server 100 (step S570), selects whether to make a collaborative engineering development from the developer terminals 310, 320, and 330 according to a corresponding request from the online development environment server 100 (step S575), and delivers the same to the online development environment server 100 (step S580). Then, the online development environment server 100 configures a virtual design and development space according to the developer's selected matters (step S585) and displays the configuration results through the developer terminals 310, 320, and 330 (step S590).

Accordingly, the developer terminals 310, 320, and 330 perform an environment configuration with respect to a development environment (step S595) and store the environment configuration information in the online development environment server 100 (step S600).

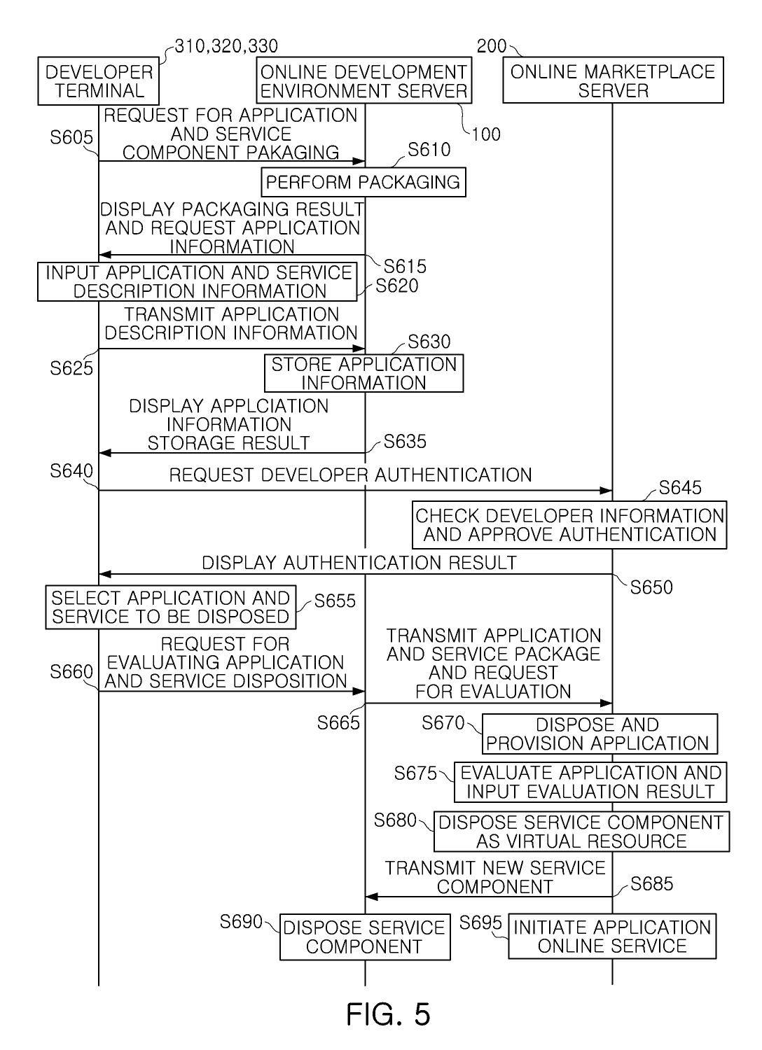

FIG. 5 is a flow chart illustrating the process of providing a developed application by using the online development environment server and the online marketplace server.

With reference to FIG. 5, when the developer finishes a development of an application or a service component by using the development environment provided from the online development environment server 100 and request packaging of the application and service component from the online development environment server 100 (step S605), the online development environment server 100 performs packaging (step S610), displays the packaging results through the developer terminals 310, 320, and 330, and requests inputting of information regarding the application (step S615).

When the developer inputs information regarding the application and the service component through the developer terminals 310, 320, and 330 (step S620) and transmits the same to the online development environment server 100 (step S625), the online development environment server 100 stores the received information (step S630) and displays the storage results through the developer terminals 310, 320, and 330 (step S635).

Thereafter, when the developer wants to dispose the packaged application or the service component in the online marketplace server 200, the developer requests the online marketplace sever 200 to authenticate the developer through the developer terminals 310, 320, and 330 (step S640). Then, the online marketplace server 200 checks developer information, performs authentication (step S645), and displays the results through the developer terminals 310, 320, and 330 (step S650).

When the developer, who has been authenticated, selects an application and a service desired to be disposed through the developer terminals 310, 320, and 330 (step S655), the developer requests the disposition and evaluation of the selected application and service from the online development environment server 100 (step S660). Then, the online development environment server 100 transmits the selected application and service package to the online marketplace server 200 and requests its evaluation (step S665).

The online marketplace server 200 disposes the corresponding application and service package and provisions the same (step S670). Thereafter, the application is evaluated by an evaluator and the evaluation results are input (step S675).

When the operation is approved according to the evaluation results, the new service component is disposed as a service component fitting the corresponding operating system, the WAS, and the like, in the virtual resource pool for operating the application in the online marketplace server 200 (step S680).

Also, the new service component is duplicated and transmitted also to the online development environment server 100 (step S685) and disposed as a service component of the virtual resource pool of the online development environment server 100 (step S690), so as to be used when a different application is developed.

Thereafter, the online marketplace server 200 initiates an online service with respect to the approved application (step S695), so that the user can purchase and use it.

As set forth above, according to exemplary embodiments of the invention, a customized development environment can be configured in real time according to various software development environment requirements of a developer in developing a new application, and an online development environment that can design, develop, utilize, store, and share software any time and anywhere can be provided. In addition, re-usability of a developed software code can be improved. Thus, software productivity can be enhanced and a software production cost can be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. An online development environment server comprising:
a virtual resource pool providing virtual resources including a design tool pool, an IDE/SDK pool, a service component, and a virtual server and repository pool;
a virtual resource pool manager supporting to allow a developer to select a virtual resource according to a selected development environment;
a virtual development environment manager establishing a virtual development environment with reference to virtual resource information through the virtual resource pool manager;
a virtual operation space and view manager binding a user and a view of a virtual development environment of each group through the virtual development environment manager and the virtual resource pool manager;
a presenter presenting a virtual view model constituted by being bound by the virtual operation space and view manager; and
a metadata manager storing metadata configured for virtualizing an operation space and managing the same.

2. The server of claim 1, further comprising:
an application modeler supporting to allow the developer to model an application;
an automatic code generator generating a code with respect to an application modeled by the application modeler;
a source code repository storing and managing the code, which has been automatically generated by the automatic code generator, by version, classifying the automatically generated code and a source code developed by the developer, and storing and managing the classified codes;
an application package repository packaging the source code developed by the developer by using the code of the source code repository, and storing and managing the same; and
a service component repository packaging a service component developed by the developer and storing and managing the same.

3. The server of claim 1, further comprising:
a charging manager performing a charging function with reference to development environment and development tool license information and contract information of the developer; and
a connection control and security manager managing a user connection control and security on a communication channel and the security of the online development environment server, and handling a developer authentication when the developer logs in.

4. The server of claim 1, further comprising:
an open API and Web service list manager managing an open API and Web service list provided from a different Web-based server and supporting the developer to apply the same in developing an application; and
a workflow engine and a workflow engine agent providing an API in developing a process application for applying a workflow and a rule.

5. The server of claim 1, further comprising:
an application life cycle manager managing information regarding each development stage of a developed application.

6. The server of claim 1, wherein virtual operation space environments and development environment constitution matters selected by the developer are stored and managed by the metadata manager, and when the developer develops a customized function for supporting a multi-tenant of an application on the selected virtual space, a user interface, a database, and a workflow are managed as metadata.

7. The server of claim 1, further comprising:
a developer database storing information regarding each developer;
an environment configuration database storing environment configuration information regarding a virtual development environment;
a metadata database storing metadata; and
an application and service list database storing information regarding each development stage with respect to an application.

8. An online marketplace server comprising:
an online marketplace portal supporting to allow a user to check a list of applications and Web services, and make a contract to use a desired application and a desired Web service;
an application manager managing a list of applications approved to be operated and supporting checking an application list and downloading of an application package through the online marketplace portal;
a provisioner disposing an application approved to be operated or a service component to allocate resources;
a virtual resource pool providing virtual resources including an application, a service component, a multi-tenant support runtime engine pool, a metadata manager, and a virtual server and repository pool;
a virtual resource pool manager establishing a virtual environment to allow a user to use an operating system and a server according to a desired application; and
a metadata manager storing and managing metadata for driving an application.

9. The server of claim 8, further comprising:
a charging manager performing a charging function with reference to license information of an application and a Web service and user's contract information; and
a connection control and security manager managing controlling a connection of a developer and a user, the security of a communication channel, and the security of the online marketplace server, and handling an authentication when the developer and the user logs in.

10. The server of claim 8, further comprising:
an open API and Web service manager managing an open API and Web service list and service state used by a disposed application and providing an open API and Web service to an external server by using a disposed service component; and
a common service component API storing a service component added as a common service among service components developed by the developer in order to support a development.

11. The server of claim 8, further comprising:
an application life cycle manager managing information regarding each development stage with respect to a developed application.

12. The server of claim 8, further comprising:
an application package repository storing and managing an application and a service package which have been developed by the developer and transmitted to the online marketplace server.

13. The server of claim 8, further comprising:
a workflow engine and a workflow engine agent supporting performing of a process management function of a process application for applying a workflow and a rule.

14. The server of claim 8, wherein the multi-tenant support runtime engine is constituted to be different according to a virtual server, an operating system and a WAS (Web Application Server) to perform a function of supporting a multi-tenant with a single application instance to provide a service.

15. The server of claim 8, wherein the metadata manager provides an application service according to the multi-tenant support runtime engine, and when a user or a tenant customizes, a user interface, a database, and a workflow are managed as metadata.

16. The server of claim 8, further comprising:
a user and developer database storing information regarding each user and each developer;
an environment configuration database storing environment configuration information;
a metadata database storing metadata; and
an application and service list database storing information regarding each development stage with respect to an application.

17. A method for configuring an online development environment, the method comprising:
checking developer registration information according to a request for authenticating a developer received from a developer terminal, and approving a log-in of a developer;
displaying a list of supportable operating systems through the developer terminal;
displaying a supportable WAS (Web Application Server), a frame work, and a list of design and development tools through the developer terminal;
constituting a virtual design and development space according to a selected development environment and whether or not a collaborative engineering development is to be made received from the developer terminal;
establishing, by the developer terminal, an environment for the configured virtual design and development space; and
storing environment configuration information of the developer terminal in an online development environment server.

18. The method of claim 17, further comprising:
when there is an application under development by the developer, displaying a list of the application under development through the developer terminal; and
re-configuring a development environment with respect to the application under development selected by the developer.

19. A method for providing an application, the method comprising:
performing packaging according to an application and a service component packaging request received from a developer terminal;
storing application and service component information received from the developer terminal;
checking developer information to perform authentication according to a developer authentication request received from the developer terminal;
when a request for disposing an application and service and an evaluation is received from the authenticated developer, transmitting a selected application and service packet to an online marketplace server;
disposing and provisioning the selected application and service package and the performing evaluation; and
disposing a new service component approved to be operated in a virtual resource pool.

20. The method of claim 19, further comprising:
transmitting the disposed new service component to the online development environment server and disposing the same in a virtual resource pool.
